(19) United States
(12) Patent Application Publication
(10) Pub. No.: US 2002/0126275 A1
(43) Pub. Date: Sep. 12, 2002

(54) LED illuminated particle detection apparatus and methods

(76) Inventor: Paul E. Johnson, Laramie, WY (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 09/804,522

(22) Filed: Mar. 12, 2001

(51) Int. Cl. G01J 3/30

(52) U.S. Cl. 356/317

(57) ABSTRACT

An LED illumination source device for use in a flow particle detector such as a flow cytometer includes an LED for providing light at a selected wavelength, an optical element having a small focal length for collecting nearly all of the light from the LED and substantially collimating it to a beam of light, and a focussing optical element for focussing the collimated beam at a selected volume within a flow sample stream. The LED may be composite LED which generates light at two wavelengths.

### BACKGROUND OF THE INVENTION

1. Field of the Invention

This invention relates to apparatus and methods for the detection of target particles in flow. In particular, the present invention relates to flow particle detection apparatus and methods which utilize light emitting diode (LED) devices as the illumination sources.

2. Description of the Prior Art

Several monographs describe the methods and applications of flow cytometry (e.g., Flow Cytometry: First Principles by A. L. Givan, 1992, and references therein). The method provides a means of identifying and sorting single cells of a variety of types. The essential aspects of the device include a means of delivering a flowing stream (the sample) to the detection region, irradiation of the detection region using a laser or other means of illumination, and the appropriate optics and detection electronics to measure the light absorption or scattering properties of microorganisms, or fluorescence from microorganisms themselves or the fluorescent labels placed onto or into the microorganisms before their delivery to the detection region. Usually, a small constant-velocity pump is used for generating the sample flow. Gravity could also be used. Irradiation is typically accomplished using a gas laser (such as an Ar or HeNe laser) or laser diode; selection of the fluorescence and rejection of the excitation beam are accomplished with a combination of filters, dichroic mirrors and beamsplitters; and detection is made with a photomultiplier tube or photodiode. One response of each microorganism (or target particle) consists of a burst of fluorescence photons generated during its passage through the irradiated region. Another consists of light scattering of photons in the illumination beam by the target particle, with an angular dependence characteristic of the size and shape of the target particle and a spectral dependence characteristic of the type of target particle. The successful detection of single organisms relies on several critical factors. First, the laser power must be sufficient to generate a large enough number of fluorescence (or alternatively, scattering) photons during the brief passage of the labeled bacterium through the irradiated region. Specifically, it is essential that the number of photons generated be large enough so that the fluorescence burst can be reliably differentiated from random fluctuations in the number of background photons. Second, reducing the background noise is important, i.e., minimizing the number of unwanted photons that strike the detector, arising from scattering and fluorescence from impurities in the flowing fluid and from the apparatus. FIG. 1 (prior art) shows a typical flow cytometry system (from Shapiro, Practical Flow Cytometry, 2nd Edition). The solution to be analyzed is in the core flow; the sheath flow serves to confine the core flow to a small diameter column, while inhibiting clogging of the core flow. A laser induces fluorescence from each microorganism in the core flow, which can be detected by a photomultiplier or photodiode (not shown). A small bore core flow allows for precision photometric measurements of cells in the flow illuminated by a small diameter laser beam; all of the cells will pass through nearly the same part of the beam and will be equally illuminated.

While lasers work well as illumination sources for cytometry, they do have several disadvantages. First, lasers are relatively expensive. Second, they are not available at all desired optical wavelengths. These two limitations are exacerbated when a combination of two or more wavelengths is desired (as is common in fluorescing systems which detect fluorescence from microorganisms themselves or from the fluorescent labels placed onto or into the microorganisms before their delivery to the detection region).

There remains a need for an illumination source for flow particle detection such as flow cytometry which is inexpensive, available in a wide variety of wavelengths, and which can provide a combination of wavelengths.

### SUMMARY OF THE INVENTION

An object of the present invention is to provide an illumination source for flow particle detection such as flow cytometry which is inexpensive, available in a wide variety of wavelengths, and which can provide a combination of wavelengths.

Accordingly, a light emitting diode (LED) illumination device comprises an LED providing illumination at one or more wavelengths, a ball lens or the like, having a very small focal length to gather most of the light from the LED and collimate it, and a focussing lens for focussing the light from the ball lens onto the sample flow zone.

Particle detection apparatus according to the present invention identifies particles in a sample stream moving through a flow zone, the sample stream containing target particles, and includes means for passing the sample stream through the flow zone, means for illuminating the sample stream within the flow zone, and a detector for detecting light emitted or scattered from illuminated target particles within the flow zone. As above, the the means for illuminating includes an LED illumination source device including an LED for providing light at a selected wavelength, an optical element having a small focal length for collecting nearly all of the light from the LED and substantially collimating it to beam, and a focussing optical element for focussing the collimated beam at a selected volume within a flow sample stream. The optical element having a small focal length might be a ball lens. Optionally, the LED is a composite LED which generates light at two wavelengths.

### BRIEF DESCRIPTION OF THE DRAWINGS

FIG. 1 (prior art) is a schematic drawing showing a conventional flow cytometry system.

FIG. 2 is a schematic drawing showing an LED illumination source device for a flow cytometer according to the present invention.

FIG. 3 is a schematic drawing showing a flow cytometer which utilizes an LED illumination source device according to the present invention.

FIG. 4 is a simplified schematic drawing showing an LED configured to provide two selected wavelengths.

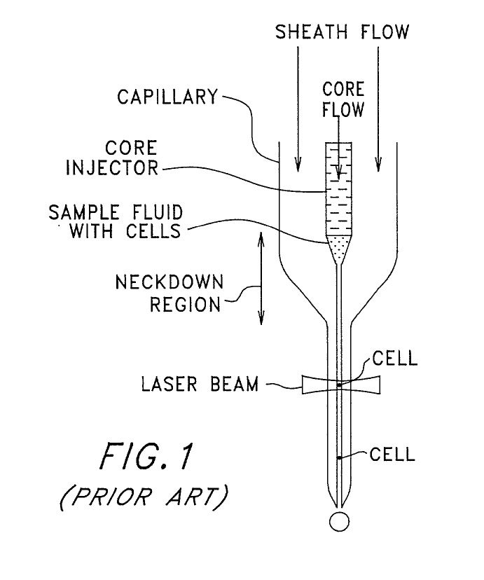

### DETAILED DESCRIPTION OF THE PREFERRED EMBODIMENTS

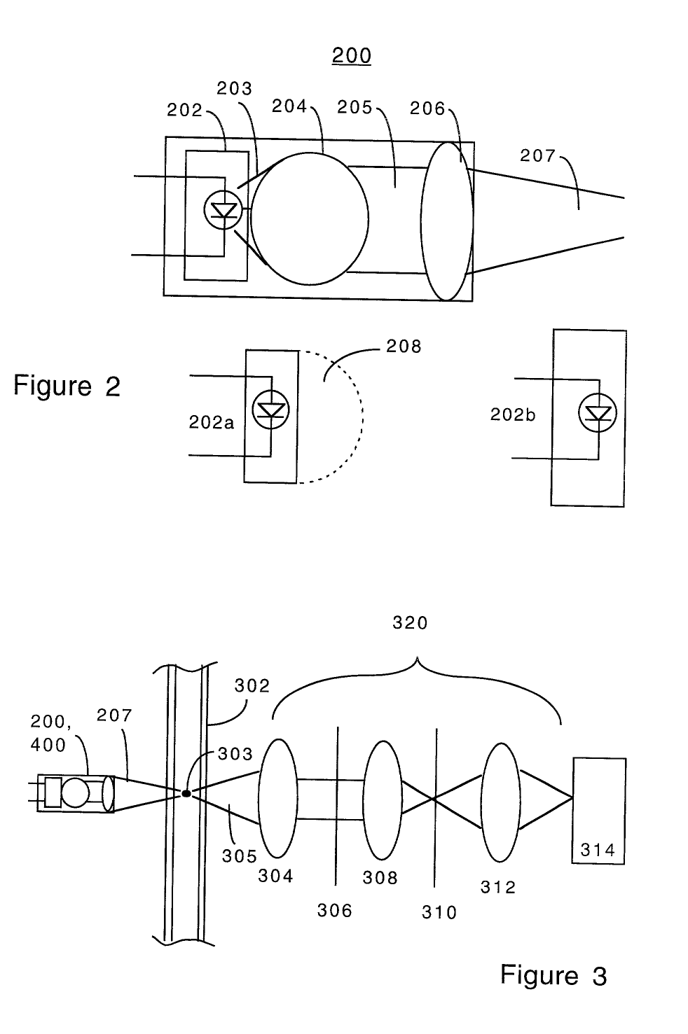

FIG. 2 is a schematic drawing showing a light emitting diode (LED) illumination source device 200 for a flow cytometer according to the present invention. The integrated lens usually present on LEDs is absent. The LED can be fabricated without the lens or the lens can be removed by cutting. When the lens is removed by cutting, the resulting cut surface should then be polished until a transparent, thin, flat layer of plastic covers the emitting element. LED 202a is an example of this. Alternatively, a side-emitting LED 202b in a (lenseless) flat pack can be used.

Note that while flow cytometry is extensively discussed herein, the same apparatus and methods apply to general flow particle detection systems.

LED 202 provides light 203 at a selected wavelength when forward biased. Optical element 204 is preferably a ball lens, though a convex lens with a very small focal length would suffice. Ball lens 204 collects nearly all of the light from LED 202 and collimates it to beam 205.

Optical element 206, for example a convex lens then focuses the light 207. The focal length of lens 206 is selected to focus the light to a tight beam at the sample stream of the cytometer (see FIG. 3).

FIG. 3 is a schematic drawing showing a flow cytometer 300 which utilizes an LED illumination source device 200 according to the present invention. LED Device 200 focuses light 207 onto cytometer sample stream 302, thus illuminating core flow. Particle 303 in sample stream 302 scatters or fluoresces light 305. In a fluorescing system, filter 306 is a notch filter which attenuates scattered light at the illuminating wavelength to reduce noise (the fluorescing wavelength(s) 303 are transmitted). In a scattering system, elements 308-314 are not in-line and filter 306 is absent.

Optics 320, comprising lenses 304, 308, and 312, and aperture (field stop) 310, serve to focus light 305 onto detector assembly 314, for example one or more photodiodes.

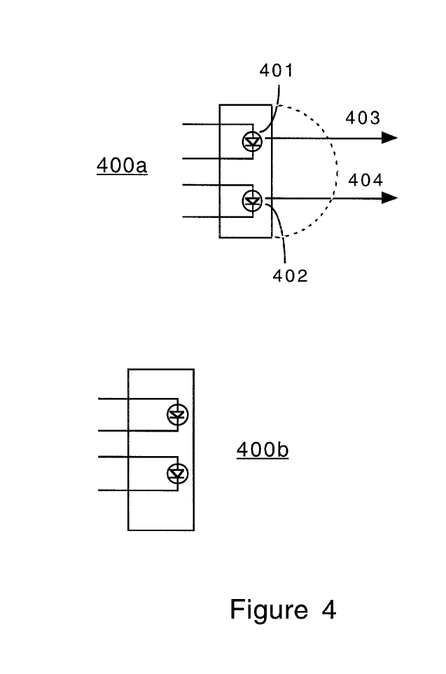

FIG. 4 is a simplified schematic drawing showing a composite LED 400 having two LED sub-elements 401, 402 configured to provide two selected wavelengths 403, 404. 400a is an LED with the lens absent or removed, and 400b is a flat pack side-emitting LED, also lenseless.

Multiple wavelengths of emission are useful in exciting two or more fluorescent dyes. For illustration, a DNA dye, such as propidium iodide may be used to interrogate cell viability. A fluorescent dye attached to an antibody can be used to detect cells of a specific serotype. Together, they may be used to detect viable and non-viable cells of a given type. By selecting dyes that emit (and possibly absorb) at two different wavelengths, both tasks can be executed simultaneously, using a dichroic mirror(s) to channel the emission to two or more different detectors within detector assembly 314, one detector detecting emission from each dye.

In this case, the system of FIG. 3 utilizes a composite LED 400 producing the two desired wavelengths, and detector assembly 314 detects both emitted wavelengths.

What is claimed is:

1. An LED illumination source device for use in a flow particle detection device comprising:
an LED for providing light at a selected wavelength; and
an optical element for collecting nearly all of the light from the LED and concentrating the collected light at a selected volume within a flow sample stream.

2. The device of claim 1, wherein the optical element comprises:a
collecting element having a small focal length for collecting the light from the LED and substantially collimating it to a roughly parallel beam of light; and
a focussing element for focussing the collimated beam.

3. The device of claim 1 wherein the collecting element is a ball lens.

4. The device of claim 1 wherein the LED is a composite LED which generates light at two wavelengths.

5. The device of claim 1 wherein the LED is a side emitting, flat pack, lenseless LED.

6. The device of claim 1 wherein the flow particle detection device is a flow cytometer.

7. Particle detection apparatus for identifying particles in a sample stream moving through a flow zone, the sample stream containing target particles, the apparatus comprising:
equipment for passing the sample stream through the flow zone;
an illumination device for illuminating the sample stream within the flow zone; and
a detector assembly for detecting light emitted or scattered from illuminated target particles within the flow zone;
wherein the illumination device includes an LED illumination source device including—
an LED for providing light at a selected wavelength; and
an optical element for collecting nearly all of the light from the LED and concentrating the collected light at a selected volume within a flow sample stream.

8. The apparatus of claim 7 wherein the optical element comprises:
a collecting element having a small focal length for collecting nearly all of the light from the LED and substantially collimating it to a parallel beam of light; and
a focussing element for focussing the collimated beam.

9. The apparatus of claim 8 wherein the collecting element is a ball lens.

10. The apparatus of claim 7 wherein the LED is a composite LED which generates light at two wavelengths.

11. The apparatus of claim 10 wherein the detector detects light emitted or scattered from illuminated target particles resulting from illumination at both selected wavelengths within the flow zone.

12. The apparatus of claim 11, wherein the sample stream includes two fluorescent dyes and the selected wavelengths cause the two dyes to emit at different wavelengths.

13. The apparatus of claim 7 wherein the particle detection apparatus is a flow cytometer.

14. Particle detection apparatus for identifying particles in a sample stream moving through a flow zone, the sample stream containing target particles, the apparatus comprising:
equipment for passing the sample stream through the flow zone;
an illumination device for illuminating the sample stream within the flow zone with two selected wavelengths; and
a detector assembly for detecting light emitted or scattered from illuminated target particles resulting from illumination at both selected wavelengths within the flow zone;
wherein the illumination device includes an LED illumination source device including—
an LED for providing light at the two selected wavelengths; and
an optical element for collecting nearly all of the light from the
LED and concentrating the collected light at a selected volume within a flow sample stream.

15. The apparatus of claim 14, wherein the detector assembly comprises two detectors for detecting emitted light at two wavelengths.

16. The apparatus of claim 14, wherein the sample stream includes two fluorescent dyes and the selected wavelengths cause the two dyes to emit at different wavelengths.

17. The apparatus of claim 16, wherein the detector assembly comprises two detectors for detecting emitted light at the two wavelengths.

18. The apparatus of claim 14 wherein the optical element comprises:
a collecting element having a small focal length for collecting nearly all of the light from the LED and substantially collimating it to a roughly parallel beam of light; and
a focussing element for focussing the collimated beam.

19. The apparatus of claim 18 wherein the collecting element is a ball lens.

20. The apparatus of claim 14 wherein the particle detection apparatus is a flow cytometer.
